(19) United States
(12) Patent Application Publication
(10) Pub. No.: US 2024/0264308 A1
(43) Pub. Date: Aug. 8, 2024

(54) TEMPORAL SUPER-RESOLUTION

(71) Applicant: Ramot at Tel-Aviv University Ltd., Tel-Aviv (IL)

(72) Inventors: David Mendlovic, Tel Aviv (IL); Dan Raviv, Tel Aviv (IL); Lior Gelberg, Tel Aviv (IL); Khen Cohen, Tel Aviv (IL); Mor-Avi Azulay, Tel Aviv (IL); Menahem Koren, Tel Aviv (IL)

(21) Appl. No.: 18/575,849

(22) PCT Filed: Jul. 7, 2022
(86) PCT No.: PCT/IB2022/056275

§ 371 Date: Dec. 31, 2023

Related U.S. Application Data
(60) Provisional application No. 63/219,378, filed on Jul. 8, 2021.

(51) Int. Cl. G01S 17/89; G01S 7/499

(52) U.S. Cl. CPC G01S 17/89; G01S 7/499; G06T 3/4053

(57) ABSTRACT

System and method for imaging a target, the method comprising transmitting a plurality of N pulses of electromagnetic waves to illuminate the target, receiving a pulse of electromagnetic waves that is reflected by the target from each of the transmitted pulses at an imager sensitive to the electromagnetic waves, integrating energy in the plurality of received pulses during a same exposure period of the imager to provide a measure of the integrated energy, and processing the measure of integrated energy to provide N images of the target.

### CROSS-REFERENCE TO RELATED APPLICATIONS

This application claims priority from U.S. Provisional Patent Application No. 63/219,378 filed Jul. 8, 2021, which is expressly incorporated herein by reference in its entirety.

### FIELD

The subject matter disclosed herein relates in general to signal processing and in particular to temporal resolution of signals in particular.

### BACKGROUND

Resolution in a digital signal is generally related to its frequency content. High-resolution (HR) signals are band-limited to a more extensive frequency range than low-resolution (LR) signals. The resolution is generally limited by two factors, physical device limitations and the sampling rate. For example, digital image resolution is typically limited by the imaging device's optics (i.e., diffraction limit) and the sensor's pixel density (i.e., sampling rate).

A technique used to increase resolution is temporal super-resolution (TSR). This technique is based on increasing the temporal sampling frequency beyond the Nyquist frequency, which is limited by the sampling rate. Different approaches may be used in applying TSR, also commonly referred to as “up-sampling”, in particular for image signals. Some rely on hardware to increase temporal frequency detection, others on software, others on deep learning models, and others on some combination of the former.

### SUMMARY

In various embodiments there is provided a method for imaging a target, the method comprising transmitting a plurality of N pulses of electromagnetic (EM) waves to illuminate the target, receiving a pulse of EM waves that is reflected by the target from each of the transmitted pulses at an imager sensitive to the EM waves, integrating energy in the plurality of received pulses during a same exposure period of the imager to provide a measure of the integrated energy, and processing the measure of integrated energy to provide N images of the target.

In various embodiments, there is provided an imaging system operable to image a target, the imaging system comprising a source of EM waves controllable to transmit a plurality of EM waves to illuminate the target, a sensor sensitive to the EM waves controllable to have an exposure period during which the sensor is enabled to receive and integrate energy in EM waves reflected by the target from the transmitted EM waves, and a controller configured to control the source of EM waves and sensor to process the measure of integrated energy to provide N images of the target.

In some embodiments, the sensor integrates energy for each of the different M characterizing features independently of integrating energy for the other distinguishing features to provide a measure of integrated energy for each of the M characterizing features.

In some embodiments, the controller processes the measure of integrated energy for each of the M features to provide N images of the target for each of the M features for a total of N×M images of the target.

In some embodiments, the controller processes the integrated energy to provide the N images comprises minimizing a cost function.

In some embodiments, the transmitted pulses of EM energy comprise EM waves characterized by M different distinguishing features.

In some embodiments, the M different distinguishing features comprise different wavelength bands of EM energy.

In some embodiments, the M different distinguishing features comprise different directions of polarization.

In some embodiments, integrating energy comprises integrating energy for each of the different M characterizing features independently of integrating energy for the other distinguishing features to provide a measure of integrated energy for each of the M characterizing features.

In some embodiments, processing the integrated energy comprises processing the measure of integrated energy for each of the M features to provide N images of the target for each of the M features for a total of N×M images of the target.

In some embodiments, processing the integrated energy to provide the N images comprises minimizing a cost function.

In some embodiments, the cost function comprises a temporal cost function.

In some embodiments, the cost function comprises a spatiotemporal cost function.

In some embodiments, the cost function comprises a Lagrangian cost function.

In some embodiments, the EM waves comprise visible light waves.

In some embodiments, the EM waves comprise infrared (IR) waves.

In some embodiments, the EM waves comprise ultraviolet (UV) waves.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale. In the drawings:

FIG. 1 illustrates schematically an exemplary imaging system including an imager, an illuminator, and a controller to control the illuminator and the imager, and to process a measure of integrated energy from the imager to provide N images of the target;

FIG. 2A is a flow chart of an exemplary operational method of the imaging system of FIG. 1;

FIG. 2B schematically shows an exemplary graph illustrating temporal relationships between exposure periods of the imager to reflected light and to transmitted pulses from the illuminator;

FIG. 3 is a flow chart of a method of processing images by the controller to generate up-sampled images of a target;

FIG. 4A illustrates two graphs that show a temporal comparison and a spectrum comparison between the three signals, TS, x1 and x3, respectively, for N=3;

FIG. 4B illustrates two graphs that show a temporal comparison and a spectrum comparison between the three signals, TS, x1 and x3, respectively, for N=4;

FIG. 4C illustrates two graphs that show a temporal comparison and a spectrum comparison between the three signals, TS, x1 and x3, respectively, for N=5;

FIG. 4D illustrates two graphs that show a temporal comparison and a spectrum comparison between the three signals, TS, x1 and x3, respectively, for N=6;

FIG. 5 illustrates examples of images obtained of the rotating fan for N=3, 4, 5, and 6, for purposes of determining motion estimation;

FIG. 6 illustrates a graph showing measurements of SNR for the combined RGB signal, and a graph showing each color independently, without the transmission of pulsed light, and with transmission of pulsed light;

FIG. 7 illustrates a graph showing measurements of Cosine similarity between the true signal and the reconstructed signal for different a values; and

FIG. 8 illustrates a graph comparing error of motion estimation in time between an original video and an up-sampled video reconstructed from the original video.

### DETAILED DESCRIPTION

Applicant has realized that TSR supported by hardware (e.g., optics or sensor) has the potential to increase the temporal sampling frequency to a much higher rate and reliability compared to the other approaches. A drawback, Applicant further realized, is the complexity of known systems and the price associated with such systems.

As a result, Applicant has developed a novel approach for TSR that allows use of an imaging system of low complexity, and provides for a high temporal sampling frequency with a high reliability of spectral reconstruction. The method uses the optical reflection properties of a “target” (an object or an entity, or an area therein) such as its surface polarity reflection and/or its spectral reflectivity (target's color). The imaging system (which may also be referred to hereinafter simply as “system”) combines an imager, a high-frequency illumination source (illuminator) which transmits electromagnetic pulses, and a controller which processes optical coding signals (reflected electromagnetic waves from the transmitted electromagnetic pulses) received by the imager at a fixed sampling rate. Optionally, the imaging system includes a neural network.

An aspect of an embodiment of the disclosure relates to a TSR method for up-sampling a sampling rate of an imaging system, optionally to enhance the system's sensitivity to high frequency features of a target, the image of which is captured by the imager. The method includes operating the imager to acquire an image of the target for each of a sequence of exposure periods having a duration T and exposure period repetition frequency fₑ substantially equal to 1/T, while simultaneously illuminating the target with a temporally periodic illumination pattern of EM waves (transmitted EM pulses). T may be in a range from 1 ms to 1 second, although it may optionally be greater than 1 second, for example, 1.3 seconds, 1.5 seconds, 1.8 seconds, 2 seconds, or even greater. The illumination pattern may have a temporal period equal to about T/N, where N is an integer greater than 1, and includes EM waves characterized by M different distinguishing features that the system processes in M different respective imaging channels. N may be in the range from 2 to 10, although it may optionally be greater than 10, for example, 12, 15, 20, 30, 45, 60, or even greater. M may be in the range from 1 to 10, although it may optionally it may be greater than 10, for example, 12, 15, 20, 30, 45, 60, or even greater.

EM waves characterized by a characterizing feature m, 1≤m≤M, may be referred to as EM waves in channel m or imaging channel m. The different distinguishing features by way of example may be different wavelength bands or directions of polarizations. Different wavelength bands may be different wavelength bands of visible light, different bands of infrared (IR) light or ultraviolet (UV) light. For each exposure period while the illumination pattern illuminates the target at an illumination period frequency f/equal to about N/T, the imager acquires one image of the target for each imaging channel, for a total of M images of the target. Each of the M images acquired for the target during a single exposure period is generated by integrating energy in EM waves reflected by the target and collected by the system in the corresponding M^{th} imaging channel from all the N periods of the illumination pattern that illuminate the target during the exposure period.

In some embodiments, data in the M images is processed to generate an image of the target for each of the N illumination periods that occur during the exposure period. The result is a total of N×M images of the target. The generated images provide a sequence of N images of the target at an effective image acquisition rate and a corresponding sampling frequency of EM waves reflected by the target equal to the illumination period frequency fₗ=N/T, which is greater than the exposure period frequency by a factor of N. At the sampling frequency N/T the sequence of images encodes temporal features of the target up to an upper bound frequency about equal to a Nyquist frequency fₗ/2=N/2T, which is greater by a factor of N (up-sampling factor) than an upper bound Nyquist frequency fₑ/2=1/2T associated with the exposure period repetition frequency fₑ.

In some embodiments, for N=M, data from the M images is sufficient to determine the N images exactly, and in accordance with an embodiment, data from the M images may be processed to determine N “exact” images of the target. For N>M, the N images are underdetermined by data in the M images, and data from the M images is processed to satisfy a constraint based on a cost function to determine approximations for the N images.

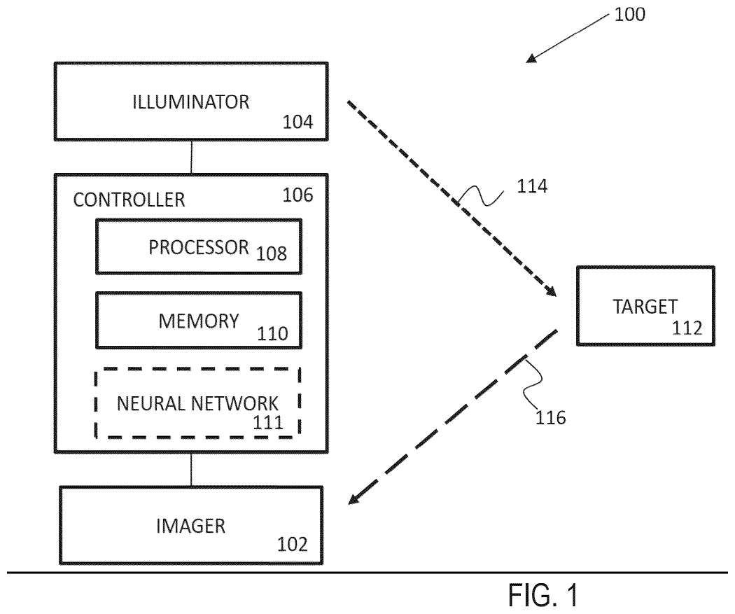

FIG. 1 schematically shows an exemplary imaging system 100 including an imager 102, an illuminator 104, and a controller 106. Also shown is a target 112 being imaged by imaging system 100, the imaging system applying TSR as described in a method below to enhance high frequency features in the target. It is noted that, although the following description is directed to the use of visible light as pulsed EM waves, other types of EM waves may be used including, for example, IR and UV.

Imager 102 may include a RGB camera or other imaging device suitable to receive EM waves 116 (for example light) reflected from target 112 and to acquire images of the target while temporally illuminated by pulsed EM waves 114 (for example pulsed light) from illuminator 104. For convenience hereinafter, light received by the imager (i.e. light 116) may be also referred to as “received light” or “reflected light”, and light transmitted by the illuminator (i.e., light 114) may be referred to as “transmitted light”, “pulsed light”, or “transmitted pulsed light”. Imager 102 may acquire images of target 112 during a sequence of exposure periods having a duration T and exposure period repetition frequency fₑ substantially equal to 1/T. Imager 102 may additionally acquire an amount of M images associated with a M number of different distinguishing features in pulsed light 114 originating from illuminator 104 and reflected back in light 116, and which may be associated with a polarization and/or color of the light, optionally RGB light. Illuminator 104 may transmit pulsed light 114 having a temporal period equal to T/N. For exemplary purposes, pulsed light 114 may be RGB light with M=3, N=6, and T=33 ms. For polarized light, it may be M=2, N=5 and T=10 ms. It is noted, as previously stated, the pulsed light 114 may be IR or UV light. Exemplary parameters for IR or UV may be M=1, N=3 and T=20 ms.

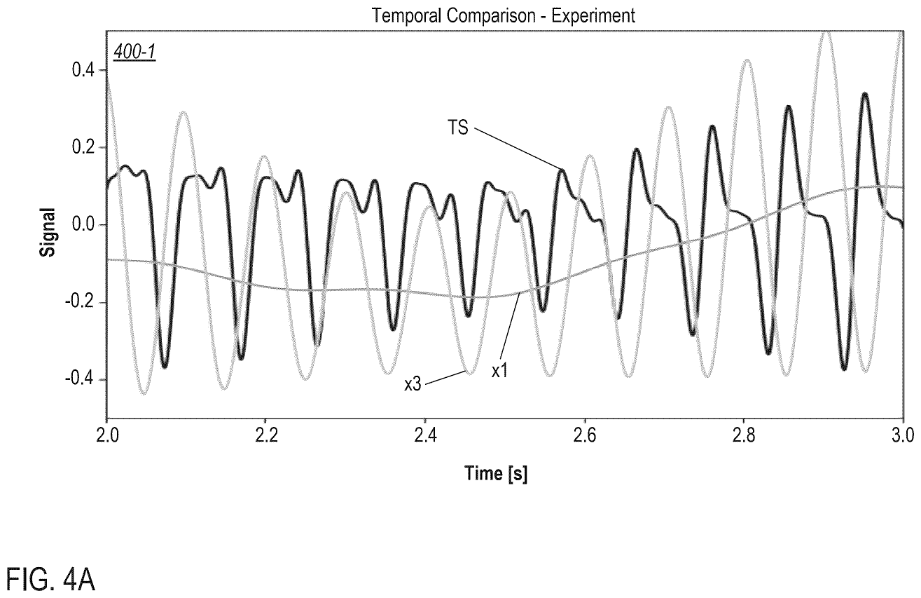

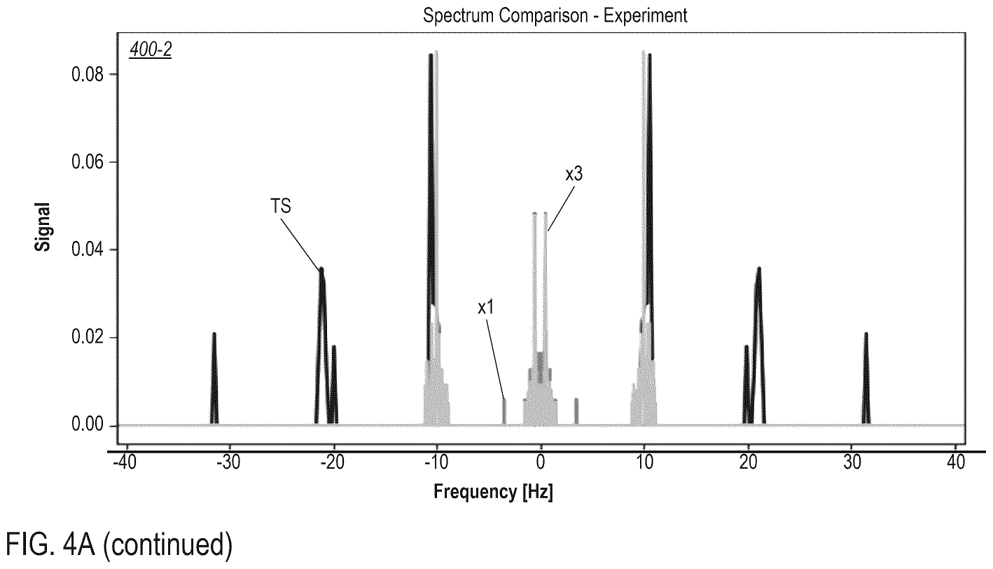

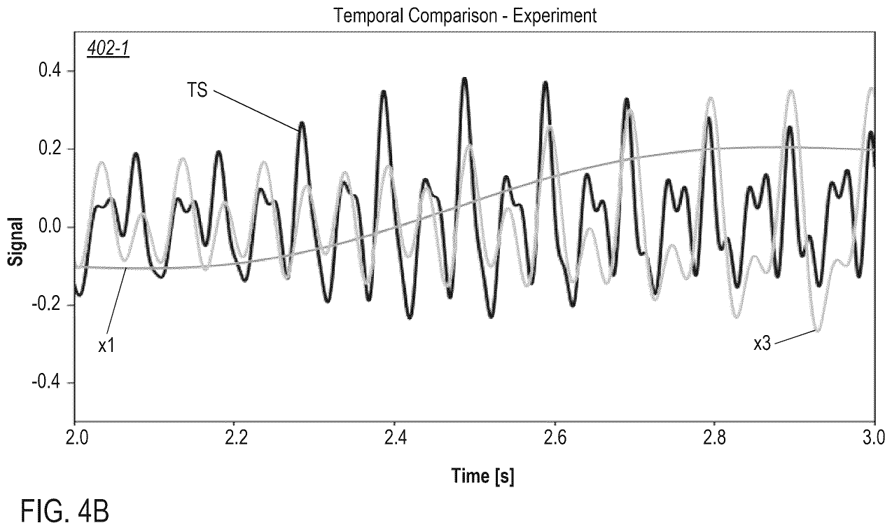

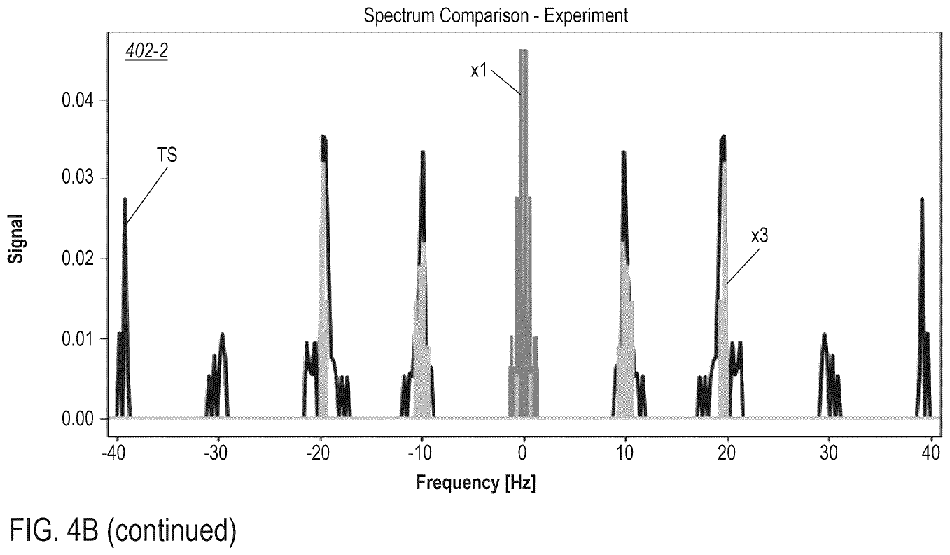

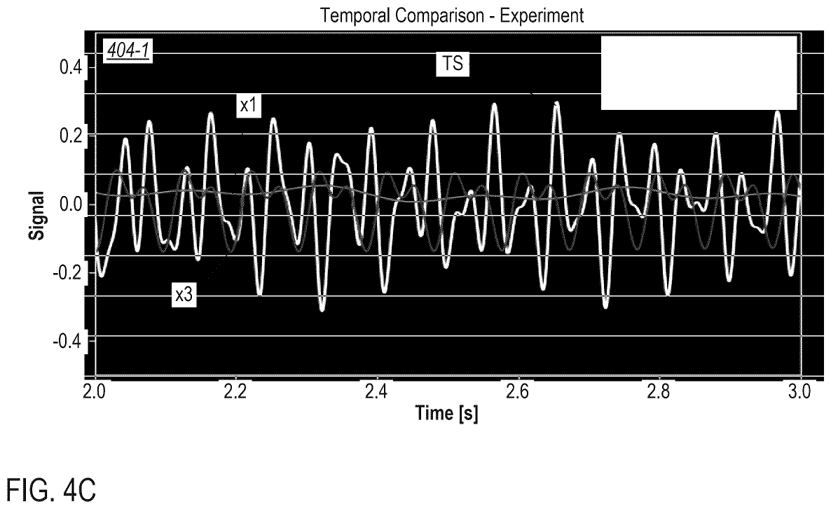

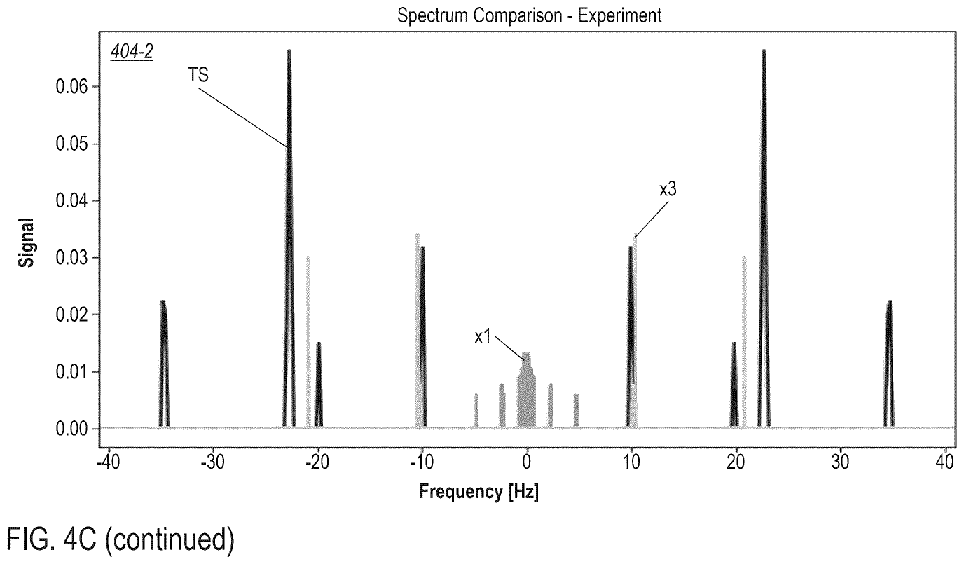

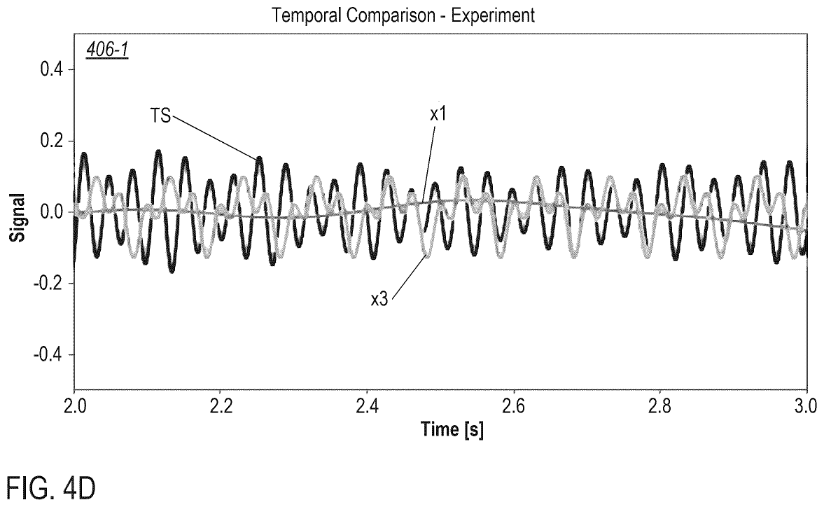

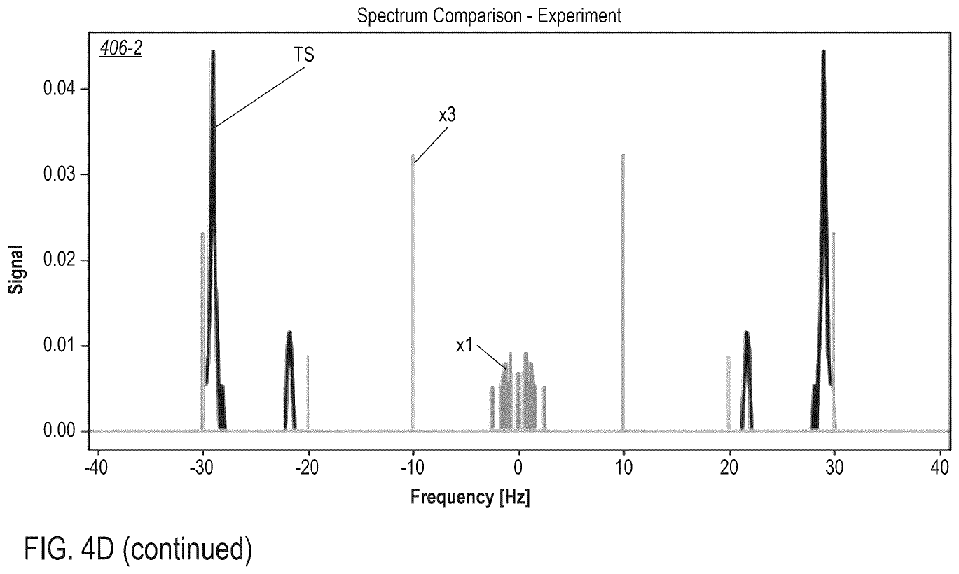

Controller 106 includes a processor 108 and a memory 110. Optionally, controller 106 includes a neural network 111. Processor 108 controls illuminator 104 to transmit and illuminate the target with pulsed light 114 for each of M different features characterizing the light according to the temporal period T/N. Processor 108 additionally controls imager 102 to receive light 116 reflected by target 112 from transmitted light 114 during a sequence of exposure periods having duration T and exposure period repetition frequency fₑ equal to about 1/T, and to register the received imaging information in M imaging channels. Processor 108 further processes the received imaging information applying a TSR algorithm as described further on below with relation to FIG. 4 in order to enhance high frequency features in the received imaging information associated with target 112. Processor 108 may additionally control all other functionalities associated with the operation of imaging system 100. It is noted that processor 108, although shown as a single unit in controller 106, may include more than one processor in the controller and/or one or more processors external to the controller.

Memory 110 may store all executable instructions required for the operation of processor 108. These may include instructions associated with the execution of the TSR algorithm. Memory 108 may additionally store the imaging information associated with the M channels generated by imager 102 from reflected light 116 for each of the M distinguishing features in pulsed light 114, as well as combined images following application of TSR. It is noted that memory 110, although shown as a single unit in controller 106, may include more than one storage unit in the controller and/or one or more storage units external to the controller and/or one or more storage units in processor 108.

Neural network (NN) 111, optionally included in controller 106, may optionally be an unsupervised NN. An exemplary NN 111 architecture may be based on Unet, and may include a first stage which may serve as an encoder and a second stage which may serve as a decoder. In the encoding stage, NN 111 may use down-sampling, optionally non-linear down-sampling such as, for example, down sampling max pool, to extract the maximum value associated with each one of the M characterizing features in the M imaging channels for all the N periods. In the decoding stage, up-sampling may be applied to transfer the mapping resulting from the first stage to a larger pixel space. Optionally, non-linear filtering using a ReLU activation filter may be applied.

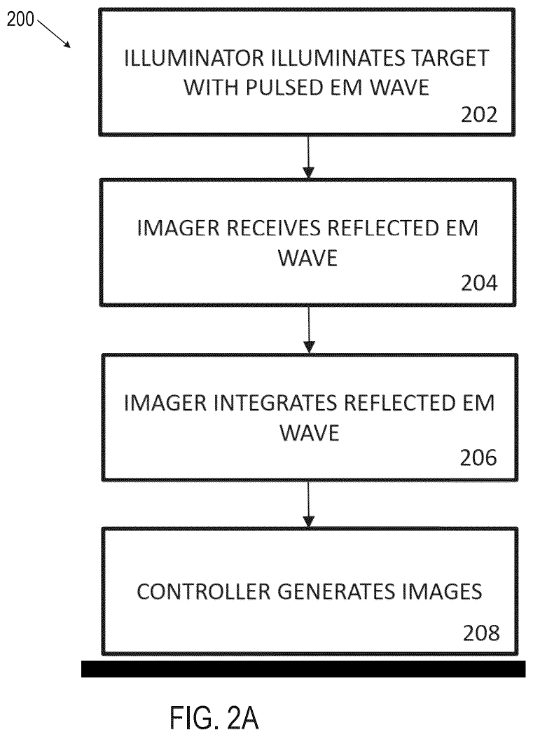

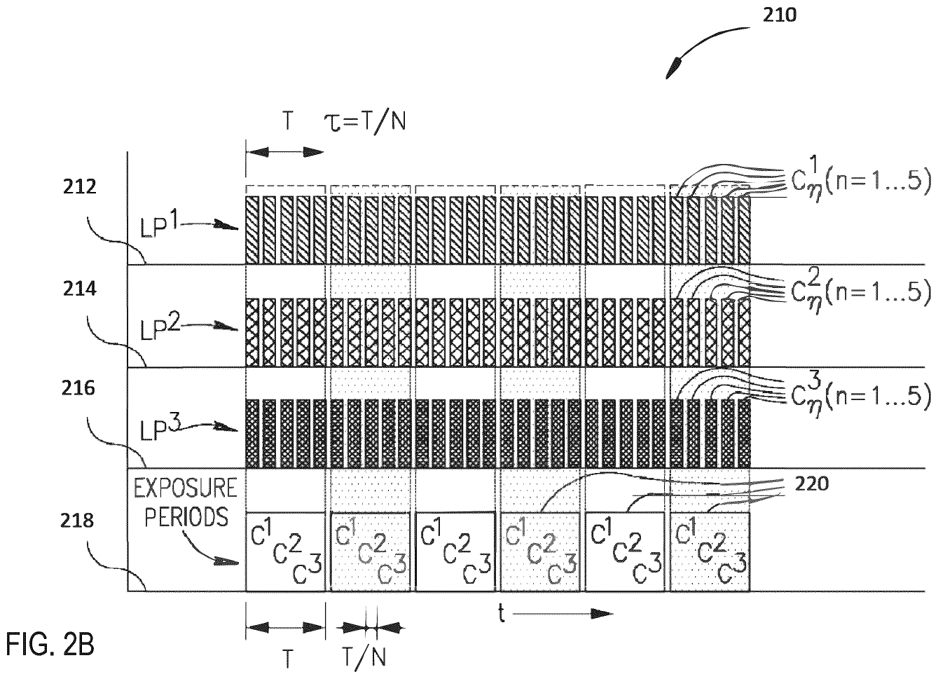

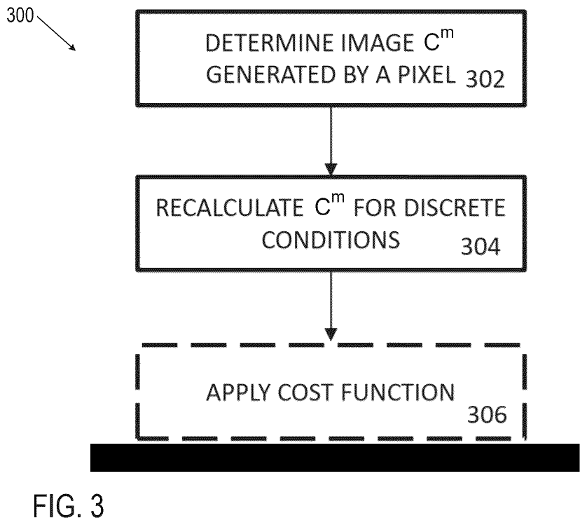

FIG. 2A is a flow chart 200 of an exemplary operational method of imaging system 100. Flow chart 200 is described, for exemplary purposes, with relation to FIG. 2B which schematically shows an exemplary graph 210 having 4 timelines 212, 214, 216, and 218 illustrating temporal relationships between exposure periods 220 of imager 102 to reflected light 116 and to transmitted pulses 114 from illuminator 104.

At block 202, illuminator 104 transmits pulse trains LP^{m} of transmitted light 114 comprising pulses cₙ^{m} having pulse widths τ=T/N at illumination frequency fₗ. For exemplary purposes, the pulsed light 114 has M=3 pulse trains LP^{m}, 1≤m≤3 of EM energy comprising optionally N=5 pulses cₙ^{m}, and 1≤n≤N=5 of EM energy respectively for each exposure period 220 of imager 102. Pulse trains LP^{m} are therefore configured having an illumination period frequency fₗ equal to about Nfₑ Pulse trains LP^{m} are optionally visible light pulse trains comprising pulses cₙ¹, cₙ², cₙ³ of R, G and B light, respectively. Pulse trains LP¹, LP², LP³ are schematically shown along timelines 212, 214, and 216, respectively.

At block 204, imager 102 receives N pulses of reflected light 116 from target 112 associated with each of the pulse trains LP^{m}. The reflected light 116 is received and registered by imager 102 during the exposure period 220. The exposure periods 220 are shown along timeline 218. During each exposure period 220, imager 102 collects and images reflected light 116 from target 112 from the N light pulses cₙ¹, cₙ², cₙ³, 1≤n≤N=5 in pulse trains LP¹, LP², LP³ of pulsed light 114 respectively, on pixels of a photosensor (not shown) comprised in the imager.

At block 206, each pixel integrates energy from the reflected light pulses imaged on the pixel in each pulse train during exposure period 220 on different respective imaging channels C^{m}, 1≤m≤3 of the pixel to register the light. Typically, an imaging channel of a pixel for registering R, G, or B light includes a light sensitive region overlaid by an R, G, or B filter respectively and electronics for integrating and converting energy in incident light that passes though the filter into an electronic signal. Let C¹, C², and C³ represent the electronic signals that a pixel generates responsive to pulses of reflected light 116 from transmitted light pulses cₙ¹, cₙ², cₙ³, by a region of target 102 that is imaged on the pixel during an exposure period 210. Signals C¹, C², and C³ may be thought of and are optionally referred to as images of the region imaged on the pixel. In FIG. 2B, exposure periods 220 are shown respectively labelled with images C₁, C², and C³ that may be generated from light in the N light pulses collected and integrated by a pixel during the exposure periods.

Images C₁, C², and C³ may be acquired at a sampling frequency equal to fₑ and the images encode data from the area on target 112 characterized by temporal frequencies in a bandwidth limited by a cutoff frequency equal to about a Nyquist frequency fₗ/2. The images may therefore be blind to high frequency features, for example ephemeral features (not shown) that are exhibited for very short periods of time.

At block 208, to increase the temporal cutoff frequency of the images acquired by imager 102, controller 106 processes images C¹, C², and C³ to generate images of target 112 for each pulse cₙ¹, cₙ², cₙ³, that illuminates the target during each exposure period 220, and provides N images of the target for each exposure period. At N images per exposure period, imager 102 operates at an effective temporal cutoff frequency equal to about N_{f}/2.

The method of processing images C₁, C², and C³ by controller 106 to generate up-sampled images of target 112 for each pulse cₙ¹, cₙ², cₙ³ is described with reference to a flow chart 300. Also described therein is the integration method employed by the sensors to generate C¹, C², and C³. It is noted that the method is described generically, for C^{m} imaging channels (i.e., images).

At block 302, to determine C^{m}, an assumption may be made that imager 102 generates images of target 102 responsive to reflected light 116 for each of M channels respectively defined by sensitivity to light in a different wavelength band represented by λₘ (1≤m≤M). Linear optics may also be assumed so that the reflected light does not undergo any changes as it optionally passes through channels. Let C^{m}(T,t) represent an image that a pixel in imager 102 generates for a particular exposure period having duration T that begins at a given time t. Let Q^{m}(λ) represent sensitivity of a pixel in imager 102 as a function of wavelength X to intensity of incident light in wavelength band λₘ and let c^{m}(λ,t) represent intensity of light in an illumination pattern that illuminator 104 transmits at time t as a function of wavelength in wavelength band λₘ. If R(λ,t) represents reflectivity of regions in target 112 at time t as a function of wavelength λ, then the pixel generates an image C^{m}(T,t) responsive to incident light reflected by a region of target 112 imaged on the pixel that may be expressed by,

$$\\ \begin{matrix}{C}^{{}_{} m} ( T , t ) = {\int }_{t}^{t + T} {dt}^{{}_{} ′} {\int }_{- ∞}^{+ ∞} {c}^{{}_{} m} ( λ , {t}^{{}_{} ′} ) {Q}^{{}_{} m} ( λ ) R ( λ , {t}^{{}_{} ′} ) d λ & ( 1 )\end{matrix}$$

Assuming that c^{m}(λ,t) is separable and may be written c^{m}(λ,t)=c^{m}(t)c^{m}(λ), then Q^{m}(λ) may be redefined to include the wavelength dependence, c^{m}(λ), of c^{m}(λ,t), and equation (1) may be written as,

$$\\ \begin{matrix}{C}^{{}_{} m} ( T , t ) = {\int }_{t}^{t + T} {c}^{{}_{} m} ( {t}^{{}_{} ′} ) {dt}^{{}_{} ′} {\int }_{- ∞}^{+ ∞} {Q}^{{}_{} ′ m} ( λ ) R ( λ , {t}^{{}_{} ′} ) d λ . & ( 2 )\end{matrix}$$

where Q′^{m}=Q^{m}(λ)c^{m}(λ).

At block 304, controller 106 may determine C^{m} for discrete conditions represented by pulsed light 114 changing in time between two modes, off and on, from equation (2). A further assumption may be made that

$$\\ \begin{matrix}{\int }_{- ∞}^{+ ∞} {Q}^{{}_{} ′ m} ( λ ) R ( λ , {t}^{{}_{} ′} ) d λ = {γ}^{{}_{} m , k} {\int }_{- ∞}^{+ ∞} {Q}^{{}_{} ′ k} ( λ ) R ( λ , {t}^{{}_{} ′} ) d λ , & ( 3 )\end{matrix}$$

where y^{m,k} are constants, and that pulsed light 114 that illuminator 104 transmits includes a pulse train having N substantially discrete pulses of light during an exposure period T, so that equation (2) may be rewritten as

$$\\ \begin{matrix}{C}^{{}_{} m} ( T , t ) = {\sum }_{n = 1}^{N} {c}_{n}^{{}_{} m} {\int }_{- ∞}^{+ ∞} {Q}^{{}_{} ′ m} ( λ ) R ( λ , {t}_{n} ) d λ = {\sum }_{n = 1}^{N} {c}_{n}^{{}_{} m} {i}_{n} , & ( 4 )\end{matrix}$$

where iₙ=∫_{-∞}^{+∞}Q′^{m}(λ)R(λ, tₙ)dλ. From equation (4), it may be appreciated that C^{m} has been determined with N being the up-sampling factor and in represents the average value of the image at a sub-time step n.

At block 306, controller 106 optionally applies a cost function. It is noted that, in equation (4) extracting the values of in is equivalent to up-sampling in factor N at the time domain. This may pose a problem as for M channels, the equation may only be solved for an un-sampling factor of N=M. As in practice, the number of channels is relatively low and a high rate of TSR is desired, a cost function may be optionally introduced.

Controller 106 may define an image of a region of target 112 imaged on a given pixel for an n-th light pulse cₙ^{m} in the m-th channel of imager 102 as IMₙ^{m}=cₙ^{m}iₙ (1≤n≤N, 1≤m≤M). Controller 106 may then operate to determine in (1≤n≤N) and thereby N images IMₙ^{m} of the facial region for a given exposure period at a time t and channel m by optionally selecting scene smoothness in time as a cost function, optionally Lagrangian, which may be given by

$$\\ \begin{matrix}{{ℒ ( t ) = {\sum }_{1}^{N - 1} [ ( {i}_{n} - {i}_{( n + 1 )} ] )}^{2} + {\sum }_{1}^{M} [ {ℒ}^{{}_{} m} ( {C}^{{}_{} m} ( T , t ) - {\sum }_{1}^{N} {i}_{n} {c}_{n}^{{}_{} m} ] )}^{2} & ( 5 )\end{matrix}$$

where [symbol] ^{m} are Lagrange multipliers. In matrix notation the solution to equation (5) may be written as

$$\\ \begin{matrix}\vec{I} = {M}^{{}_{} - 1} {S ( {S}^{{}_{} ⊤} {M}^{{}_{} - 1} S )}^{- 1} \cdot \vec{C} , & ( 6 )\end{matrix}$$

where vectors \vec{I} and \vec{C} and matrices S and M are defined as follows:

$$\\ \begin{matrix}{S}_{( N , M )} = ( \vec{c} {}^{{}_{} 1} … \vec{c} {}^{{}_{} M} ) , {\vec{C}}_{( M , 1 )} = ( \begin{matrix}{C}^{{}_{} 1} \\ ⋮ \\ {C}^{{}_{} M}\end{matrix} ) & ( 7 )\end{matrix}$$

$$\\ \begin{matrix}{M}_{( N , N )} = ( \begin{matrix}4 & - 2 & 0 & … & 0 \\ - 2 & 4 & - 2 & … & 0 \\ 0 & - 2 & 4 & … & 0 \\ & & ⋮ & & \\ 0 & … & - 2 & 4 & - 2 \\ 0 & … & 0 & - 2 & 4\end{matrix} ) , {\vec{I}}_{( N , 1 )} = ( \begin{matrix}{i}_{1} \\ ⋮ \\ {i}_{N}\end{matrix} ) & ( 8 )\end{matrix}$$

where \vec{I} is the intensity vector of size N for each exposure time, \vec{C} is of size M and is the captured value in each of the channels for a single exposure time, \vec{c} have binary values of 0 or 1 when the pulse of channel m is on or off, and M represents the Lagrange multiplier for each of the channels.

In the above description, controller 106 determines values for in and therefrom IMₙ^{m} responsive to the Lagrangian cost function defined by equation (5). However, the cost function to be applied may not be limited to equation (5), which may be considered a temporal cost function that provides N images for a given pixel for each channel M as a function of a temporal sequence of images C^{m}(T,t) provided only by the given pixel. For example, an alternative cost function may provide N images for a given pixel as a function of images provided by pixels in a pixel neighborhood “P” of a given pixel.

Let an image provided by a given pixel at pixel coordinates x, y for an exposure period T that begins at a given time t be denoted by C_{x,y}^{m} (T, t). A Lagrangian cost function that controller 106 may process to determine images IMₙ^{m} for a given pixel C_{x,y}^{m} (T, t) may be a spatiotemporal cost function responsive not only to a temporal sequence of images provided by the given pixel but also to images provided by pixels in a pixel neighborhood of the given pixel. Optionally, the pixel neighborhood may be a 4-neighborhood. An optional spatiotemporal Lagrangian 4-neighborhood cost function, by way of example, may be given by the expression:

$$\\ \begin{matrix}{{ℒ ( t ) = {\sum }_{-} 1 \hat{} ( N - 1 ) [ {\sum }_{-} ( x , y ϵ P ) [ \{ {w}_{-} ( x , y ) \hat{} t ( {i}_{x , y , n} - {i}_{x , y , n + 1} ] ) ]}^{2} + {w}_{-} ( x , y ) \hat{} {s ( {i}_{x , y , n} - {i}_{x , y \pm 1 , n} )}^{2} + {w}_{-} ( x , y ) \hat{} {s ( {i}_{x , y , n} - {i}_{x \pm 1 , y , n} )}^{2} \} + {\sum }_{-} 1 \hat{} M [ [ {\sum }_{-} ( x , y ϵ P ) ℒ ] {}_{-} ( x , y ) \hat{} m ( {C}_{-} ( x , y ) \hat{} m ( T , t ) - {\sum }_{-} 1 \hat{} N [ {i}_{x , y , {n}^{{}_{} c} {}_{-} ( x , y , n )} \hat{} m ] ] )}^{2} , & ( 9 )\end{matrix}$$

where w_{x,y}^{t}, w_{x,y}^{s}, and w_{x,y}^{s} are weights.

Applicant conducted a number of tests to evaluate the efficacy of the disclosed method for TSR which allows use of an imaging system of low complexity, and allows a high temporal sampling frequency with a high reliability of spectral reconstruction. A description of the tests and the results obtained is given below.

### A. Test Setup

The test setup included use of a commercial CMOS camera with adjustable speed as the imager, a smartphone as the illuminator set at a refresh rate of 60 Hz, and a rotating home fan with the blades covered in white paper sheet as the target. The camera was set at different frame speeds, 10 Hz, 20 Hz, and 80 Hz. The rotating speed of the fan at approximately 21.5 Hz. For every N, the same coded pattern was used. The temporal illumination was RGB light with the following characteristics:

$$\\ \begin{matrix}{N = 3 : {b}^{\to } = ( 1 , 0 , 0 ) , {g}^{\to } = ( 0 , 1 , 0 ) , {r}^{\to } = ( 0 , 0 , 1 )}_{} \\ {N = 4 : {b}^{\to } = ( 1 , 0 , 0 , 1 ) , {g}^{\to } = ( 1 , 0 , 1 , 0 ) , {r}^{\to } = ( 0 , 1 , 0 , 1 )}_{} \\ {N = 5 : {b}^{\to } = ( 0 , 1 , 0 , 0 , 0 ) , {g}^{\to } = ( 1 , 0 , 1 , 0 , 1 ) , {r}^{\to } = ( 0 , 0 , 0 , 1 , 0 )}_{} \\ N = 6 : {b}^{\to } = ( 1 , 0 , 1 , 0 , 1 , 0 ) , {g}^{\to } = ( 0 , 1 , 0 , 1 , 0 , 1 ) , {r}^{\to } = ( 1 , 1 , 1 , 1 , 1 , 1 )\end{matrix}$$

To avoid noise artifacts, white noise filtering was applied for all the measured signals during the testing.

Illumination correction was introduced as a comparison was made between the actual signal (which was captured in the high frame-per-second recording) with the same signal captured with a low frame-per-second (and up-sampled). A compensation gain for the high frame-per-second signal was made to overcome the illumination difference due to the different exposure time. An additional correction was made due to the object color (the gamma-factors), representing the reflections for R, G and B. To detect the gamma factors to balance the intensities for all colors, a reference measurement of a white target (the center of the fan) was used to calibrate the intensity values relative to it.

### B. Test Results

The experimental results are shown in the graphs in FIGS. 4A-4D. TS is the true signal which is that transmitted by the illuminator; x1 is the signal as seen by the imager prior to up-sampling; and x3 is the up-sampled signal. The camera fps is 10 Hz and Nyquist frequency is 5 Hz. Following is a description of FIGS. 4A-4D:

FIG. 4A illustrates graphs 400-1 and 400-2 that show a temporal comparison and a spectrum comparison between the three signals, TS, x1 and x3, respectively, for N=3.

FIG. 4B illustrates graphs 402-1 and 402-2 that show a temporal comparison and a spectrum comparison between the three signals, TS, x1 and x3, respectively, for N=4.

FIG. 4C illustrates graphs 404-1 and 404-2 that show a temporal comparison and a spectrum comparison between the three signals, TS, x1 and x3, respectively, for N=5.

FIG. 4D illustrates graphs 406-1 and 406-2 that show a temporal comparison and a spectrum comparison between the three signals, TS, x1 and x3, respectively, for N=6.

In FIGS. 4A-4D, the signal axis is unitless and serves to provide a measure of the comparison. It may be seen from the results that spectral components are successfully detected up to a frequency of 30 Hz.

### C. Imaging Results

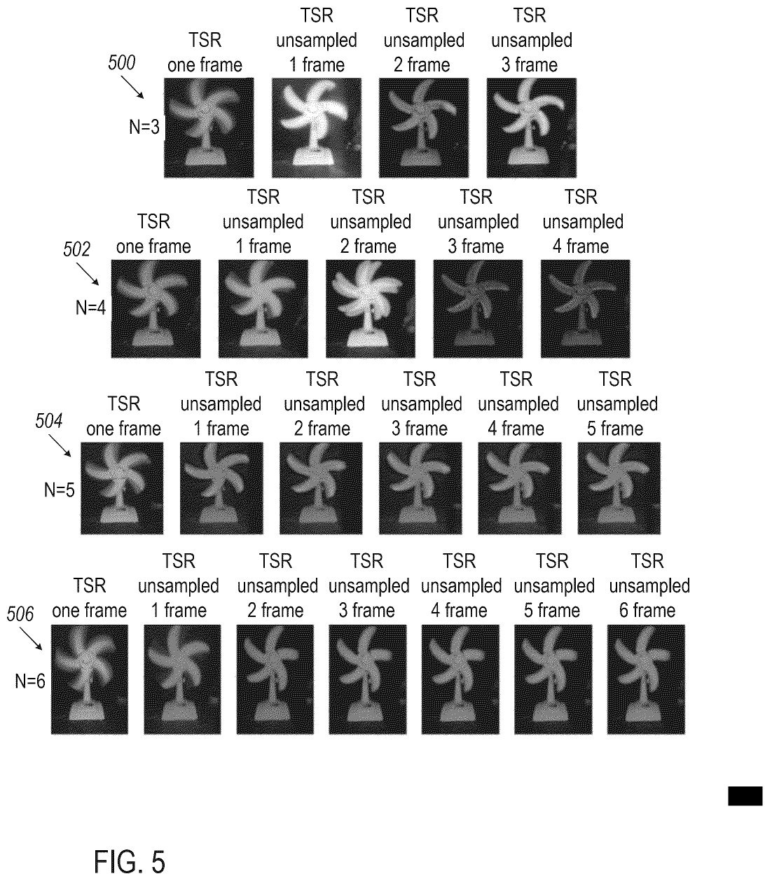

The imaging results are shown in FIG. 5 for N=3, 4, 5, and 6, as shown by rows 500, 502, 504, and 506, respectively. The first frame in each row 500-506, indicated by “TSR one frame” is the image as seem by the imager prior to up-sampling. The following frames in each row are the up-sampled images sequentially generated based on N (N=3, 3 frames; N=4, 4 frames; N=5, 5 frames; and N=6, 6 frames).

### D. SNR and Performance Result

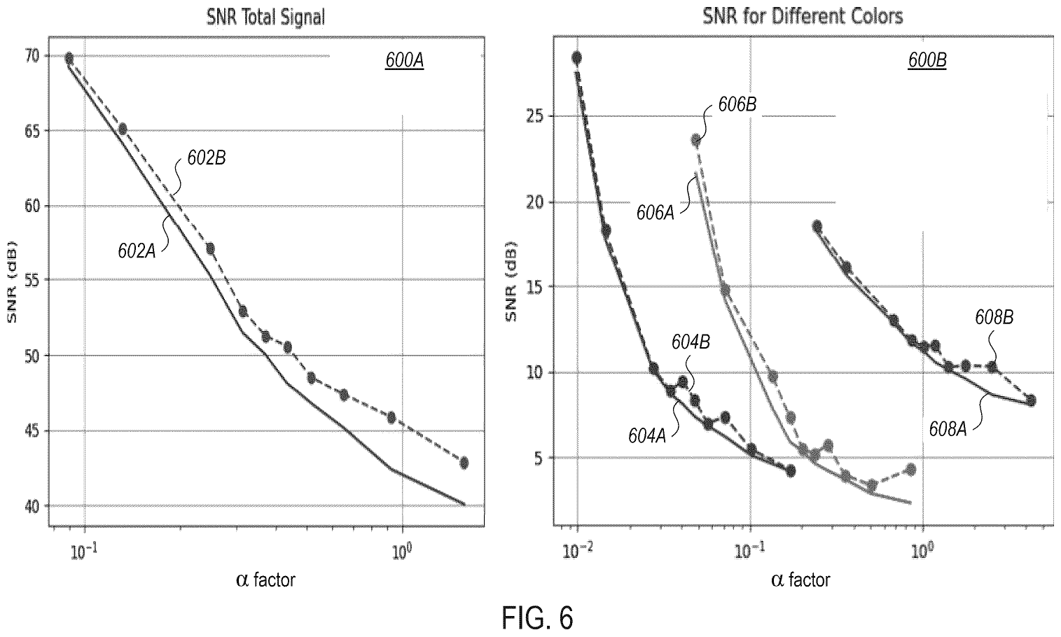

To evaluate the SNR for different a factors, a clean, white paper located 40 cm in front of the camera and the illuminator was used. Different environment illumination using a white-light projector was also used. The illumination values were measured using a Lux-meter. The results are shown in FIG. 6, and described below:
(a) Graph 600A illustrates a measure of system SNR vs. a (light intensity) for combined RGB light when the illumination light is transmitted without pulses, indicated by 602A, and when transmitted with pulses, as indicated by 602B.
(b) Graph 600B illustrates a measure of the system SNR vs. a for each light color separately when each light colour is transmitted without pulsing and with pulsing. SNR for blue color light is shown by 604A and 604B for continuous blue light and pulsed blue light, respectively. SNR for red color light is shown by 606A and 606B for continuous red light and pulsed red light, respectively. SNR for green color light is shown by 608A and 608B for continuous green light and pulsed green light, respectively.

It may be appreciated that the SNR is improved with the use of the illuminator as it increases the light in the scene

### E. Signal Reconstruction Performance Result

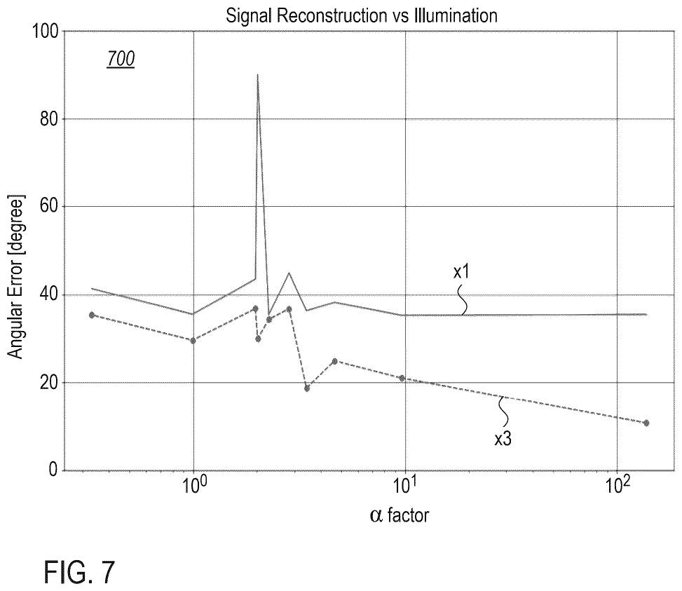

An additional experiment was to measure the signal reconstruction performance (angular error) versus the a factor. The Cosine similarity was determined for x1 and x3 for different values of a. The results are shown in FIG. 7 in graph 700 for N=3. Degradation in the performance of the disclosed TSR method was noticed when decreasing the a factor, which is related to an increase in the illumination of the environment relative to the illuminator.

### F. Motion Estimation Improvement

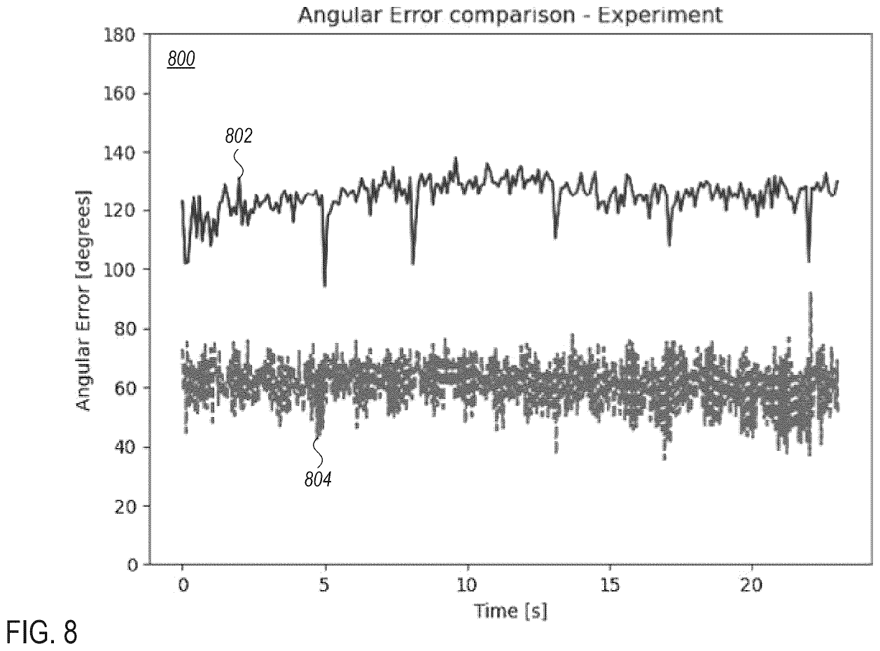

One fundamental task in computer vision is motion estimation or optical flow estimation. Given the image's spatial and temporal derivatives, one can calculate the velocity of a pixel in the x-y plane. Estimation of the temporal derivative relies heavily on the camera frame-per-second rate. Since high temporal frequencies cannot be detected in a low frame-per-second camera, using the disclosed TSR method together with increasing the camera frame-per-second can improve the temporal. The rotating fan's blade velocity (at the x-y plane) was measured at each pixel and compared to the ground truth, which was detected using a high frame-per-second camera. The result is shown in FIG. 8 in graph 800, which shows the angular error over time for a video captured of the rotating fan blades before up-sampling, as shown at 802, and after up-sampling as shown at 804.

It may be appreciated that there is a substantial improvement in the error by using the disclosed up-sampling method.

Some stages (steps) of the aforementioned method(s) may also be implemented in a computer program for running on a computer system, at least including code portions for performing steps of the relevant method when run on a programmable apparatus, such as a computer system or enabling a programmable apparatus to perform functions of a device or system according to the disclosure. Such methods may also be implemented in a computer program for running on the computer system, at least including code portions that make a computer execute the steps of a method according to the disclosure.

A computer program is a list of instructions such as a particular application program and/or an operating system. The computer program may for instance include one or more of: a subroutine, a function, a procedure, a method, an implementation, an executable application, an applet, a servlet, a source code, code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

All references mentioned in this specification are herein incorporated in their entirety by reference into the specification, to the same extent as if each individual reference was specifically and individually indicated to be incorporated herein by reference. In addition, citation, or identification of any reference in this application shall not be construed as an admission that such reference is available as prior art to the present disclosure.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

What is claimed is:

1. A method for imaging a target, comprising:
transmitting a plurality of N pulses of electromagnetic (EM) waves to illuminate the target;
receiving a pulse of EM waves that is reflected by the target from each of the transmitted pulses at an imager sensitive to the EM waves;
integrating energy in the plurality of received pulses during a same exposure period of the imager to provide a measure of integrated energy; and
processing the measure of integrated energy to provide N images of the target.

2. The method of claim 1, wherein the transmitted pulses of EM energy comprise EM waves characterized by M different distinguishing features.

3. The method of claim 2, wherein the M different distinguishing features comprise different wavelength bands of EM energy.

4. The method of claim 2, wherein the M different distinguishing features comprise different directions of polarization.

5. The method of claim 2, wherein the integrating energy comprises integrating energy for each of the different M characterizing features independently of integrating energy for the other distinguishing features to provide a measure of integrated energy for each of the M characterizing features.

6. The method of claim 5, wherein the processing the integrated energy comprises processing the measure of integrated energy for each of the M features to provide N images of the target for each of the M features for a total of N×M images of the target.

7. The method of claim 1, wherein processing the integrated energy to provide the N images comprises minimizing a cost function.

8. The method of claim 7, wherein the cost function comprises a temporal cost function.

9. The method of claim 7, wherein the cost function comprises a spatiotemporal cost function.

10. The method of claim 7, wherein the cost function comprises a Lagrangian cost function.

11. The method of claim 1, wherein the EM waves comprise visible light waves.

12. The method of claim 1, wherein the EM waves comprise infrared (IR) waves.

13. The method of claim 1, wherein the EM waves comprise ultraviolet (UV) waves.

14. An imaging system operable to image a target, comprising:
a source of electromagnetic (EM) waves controllable to transmit a plurality of EM waves to illuminate the target;
a sensor sensitive to the EM waves controllable to have an exposure period during which the sensor is enabled to receive and integrate energy in EM waves reflected by the target from the transmitted EM waves; and
a controller configured to control the source of EM waves and the sensor to process the measure of integrated energy to provide N images of the target.

15. The imaging system of claim 14, wherein the transmitted pulses of EM energy comprise EM waves characterized by M different distinguishing features.

16. The imaging system of claim 15, wherein the M different distinguishing features comprise different wavelength bands of EM energy.

17. The imaging system of claim 15, wherein the M different distinguishing features comprise different directions of polarization.

18. The imaging system of claim 15, wherein the sensor integrates energy for each of the different M characterizing features independently of integrating energy for the other distinguishing features to provide a measure of integrated energy for each of the M characterizing features.

19. The imaging system of claim 18, wherein the controller processes the measure of integrated energy for each of the M features to provide N images of the target for each of the M features for a total of N×M images of the target.

20. The imaging system of claim 14, wherein the controller processes the integrated energy to provide the N images comprises minimizing a cost function.

21. The imaging system of claim 20, wherein the cost function comprises a temporal cost function.

22. The imaging system of claim 20, wherein the cost function comprises a spatiotemporal cost function.

23. The imaging system of claim 20, wherein the cost function comprises a Lagrangian cost function.

24. The imaging system of claim 14, wherein the EM waves comprise visible light waves.

25. The imaging system of claim 14, wherein the EM waves comprise infrared (IR) waves.

26. The imaging system of claim 14, wherein the EM waves comprise ultraviolet (UV) waves.
